(19) United States
(12) Patent Application Publication
(10) Pub. No.: US 2023/0081353 A1
(43) Pub. Date: Mar. 16, 2023

(54) INLINE DISPENSING SYSTEM

(71) Applicant: King Technology Inc., Hopkins, MN (US)

(72) Inventors: Eric Barton, Eden Prairie, MN (US); Jeffrey D Johnson, Edina, MN (US); Darrin M Swagel, Minnetonka, MN (US)

(73) Assignee: King Technology Inc., Hopkins, MN (US)

(21) Appl. No.: 17/941,507

(22) Filed: Sep. 9, 2022

Related U.S. Application Data
(60) Provisional application No. 63/360,217, filed on Sep. 14, 2021.

(51) Int. Cl. E04H 4/12

(52) U.S. Cl. CPC E04H 4/1281

(57) ABSTRACT

An inline dispensing system having a collar engageable with an inline well to support an inline cap thereon and for directing a cartridge carrier into a sealing relation therewith as a cartridge carrier is inserted into an inline well in a container of a body of recreational water.

### CROSS REFERENCE TO RELATED APPLICATIONS

This application contains priority from provisional application Ser. 63/360,217; filed Sep. 14, 1921.

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

The use of inline systems to deliver dispersants into a body of water such as a hot tub is shown in King U.S. Pat. Nos. 6,328,900; 7,052,615 and 7,883,623. Typically, inline system dispensers are contained in a dispenser housing with the dispensers containing dispersants that are delivered into the body of water as water flows past the dispensers, which are located in axial alignment in an elongated housing. In one example, a cartridge carrier, which contains cartridge dispensers, is inserted into a well in the hot tub. Once the cartridge carrier is inserted into the inline well, one rotates a cap on the hot tub that brings the threads on the cap and the threads on the inline well into sealing engagement to prevent leakage therebetween. From time to time, such action may cause a problem in removing the cap for replacement of a dispensing cartridge. For example, if the cap is overtightened, or if temperature changes occur in the cap and well it may make it difficult to remove the cap and replace dispensers in the cartridge carrier.

### SUMMARY OF THE INVENTION

An inline well with a multithreaded collar including a first set of threads engageable with an inline well cap and a second set of threads engageable with a cartridge carrier. In one embodiment, a well cap is rotatably engageable with the first set of threads and a cartridge carrier is rotatably engageable with the second set of threads to axially displace a seal on the cartridge carrier into a sealing engagement with the multithreaded collar.

### BRIEF DESCRIPTION OF THE DRAWINGS

FIG. 1 shows a hot tub with an inline well for dispensing dispersant into a body of recreational water;

FIG. 2 is an isolated perspective view of the inline well and an inline cap in engagement with each other;

FIG. 3 is an exploded view of the inline well of FIG. 2;

FIG. 4 is a sectional view of a cartridge carrier, a multithreaded collar, and an inline well cap in engagement with each other along a central axis;

FIG. 4A is a sectional view of the multithreaded collar of FIG. 4 with thread diameter designations of the multiple threads in the multithreaded inline collar;

FIG. 4B is an isolated view of a sealing ring carried in a circular channel in a cartridge carrier;

FIG. 5 is an isolated view of a portion of the multithreaded inline collar to reveal a cartridge carrier hub stop in the inline collar;

FIG. 6 is a partial view of a cartridge carrier and a multithreaded inline collar showing a rotatable hub of the cartridge carrier in engagement with a portion of the multithreaded inline collar prior to axially displacing the cartridge carrier into sealing engagement with the multithreaded inline collar;

FIG. 6A is an isolated view of a stop on the cartridge carrier hub;

FIG. 7 is a partial view of the rotatable hub of a cartridge carrier with an extension located on the cartridge carrier hub for limiting a downward axially displacement of the sealing ring by preventing further rotation of the hub;

FIG. 8 is a partial view of the cartridge carrier and the multithreaded inline collar showing the rotatable hub of the cartridge carrier in sealing engagement with an annular sealing region on the multithreaded inline collar;

FIG. 8A is an isolated view showing the extension on the cartridge carrier hub and a stop on the multithreaded inline collar in engagement with each other to prevent further rotation of the cartridge carrier hub with respect to the multithreaded inline collar;

FIG. 9 is an exploded view, partially in section showing a set of resilient hooks on the top of a cartridge carrier skeleton housing that allows the handle and hub of the cartridge carrier to rotate independently of the cartridge carrier skeleton housing; and

FIG. 10 is an isolated view of a cartridge carrier with a rotatable hub and a skeleton housing of the cartridge carrier having a compartment for inserting a cartridge dispenser therein with the cartridge carrier include an end connector for securing a second cartridge dispenser thereto.

### DESCRIPTION OF THE PREFERRED EMBODIMENT

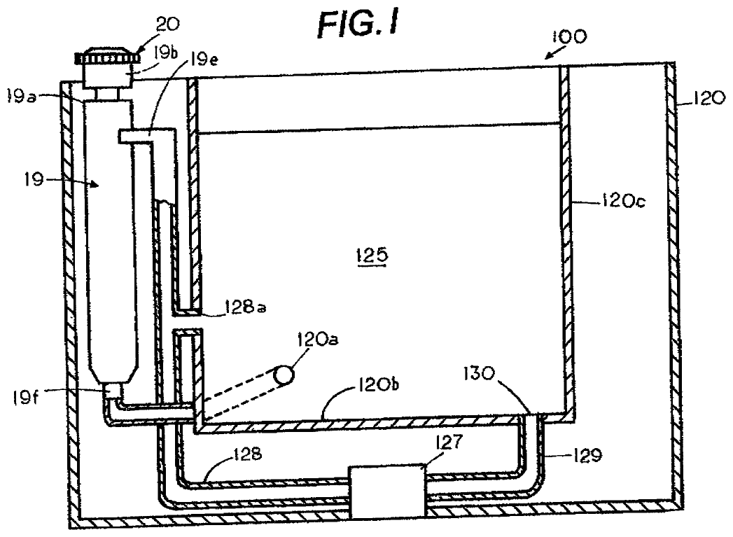

FIG. 1 is a cutaway view showing a recreational water system 100 with an outer housing 120 having an inner container 120c, which is partially filled with a fluid, such as water 125. Typically, system 100 can be in a pool, a hot tub or the like where a fluid treatment is required to maintain the water in a user-friendly condition. For example, the system can be used for treating water that may be used either for work, pleasure or for drinking.

In the embodiment shown container 120c is configured in a hot tub mode with a seating area 120b, an inlet 130 positioned to draw water into an inlet pipe 129 through a pump 127. Pump 127 increases the pressure of the water and forces the water through a fluid conduit 128 on the outlet side of the pump 127 where a portion of the water discharges through underwater port 128a as a high-pressure fluid jet. The high-pressure fluid jet provides multiple functions, for example, in a hot tub, the high-pressure fluid jet produced by the pump 127 circulates the water 125 in the hot tub thus ensuring that water purification materials in the hot tub are dispersed throughout the hot tub. In addition, the high-pressure jet can also provide a water massage to a user sitting in the hot tub.

Typically, the downstream velocity of the high-pressure jet that enters inline well housing 19 through inlet 19e is decreased through an orifice or restriction, which reduces the velocity of the water flowing through dispersants that are in a chamber in inline well housing 19. Water, which enters inline well housing 19 through inlet 19e typically flows through a cartridge dispenser where dispersants therein are carried into the main body of water 125 through outlet 19f and port 120a.

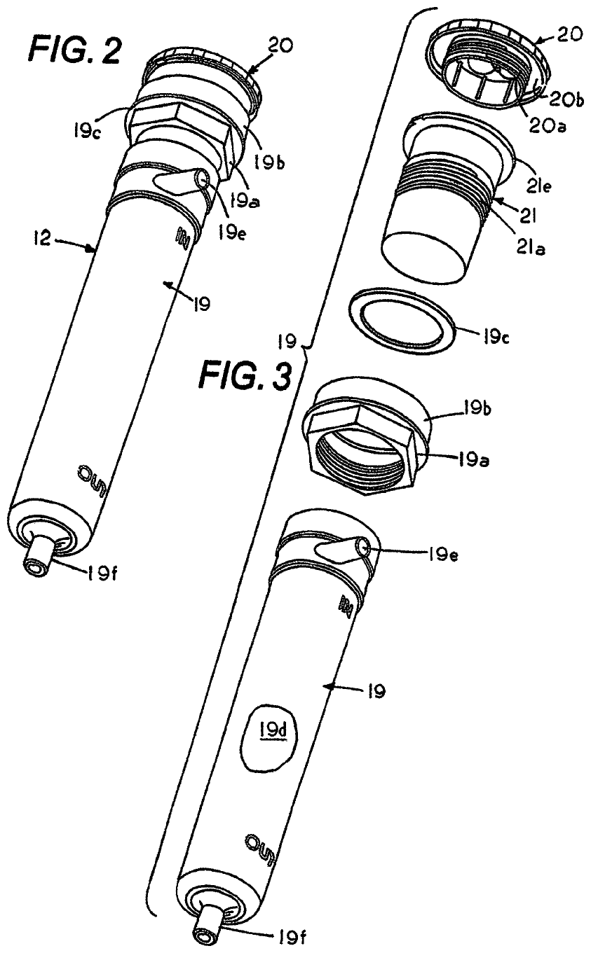

FIG. 2 shows an example of an inline well 12 that is placeable in a hot tub with the inline well having a water inlet 19e on one end and a water outlet 19f on the opposite end of housing 19. Typically, a cartridge carrier such as shown in FIG. 10 is located therein. Inline well 12 includes a connector 19a and a washer 19c and sleeve 19b that can be used to secure inline well 12 to the frame of a hot tub or the like. A well cap 20 rotationally attaches to the top end of inline well 12.

FIG. 3 is an exploded view of the inline well of FIG. 2 showing inline well housing 19 partly in section to reveal a chamber 19d therein for supporting cartridge dispensers in a dispensing condition as water flows from inlet 19e to outlet 19f. Attached to the top end of housing 19 is a connector 19a having internal threads, a sleeve 19b, a washer 19c, and a multithreaded collar 21 with internal threads and external threads 21a. An inline well cap 20 with external threads 20a rotationally attaches to collar 21 to bring annular cap seat 20b into engagement with flange 21e. To replace a spent dispensing cartridge in the inline well housing 19 one removes well cap 20 from multithreaded collar 21 through an opposite rotation of inline well cap 20.

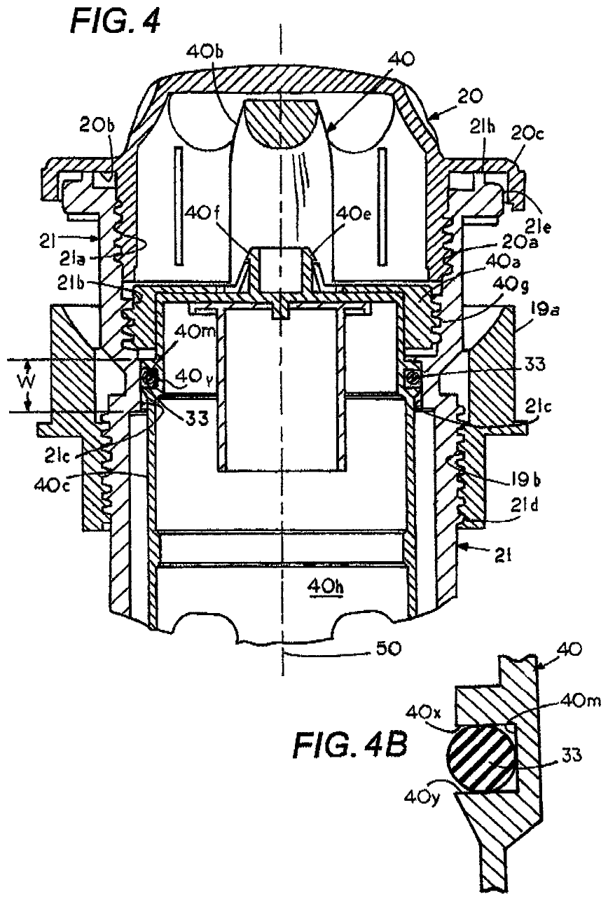

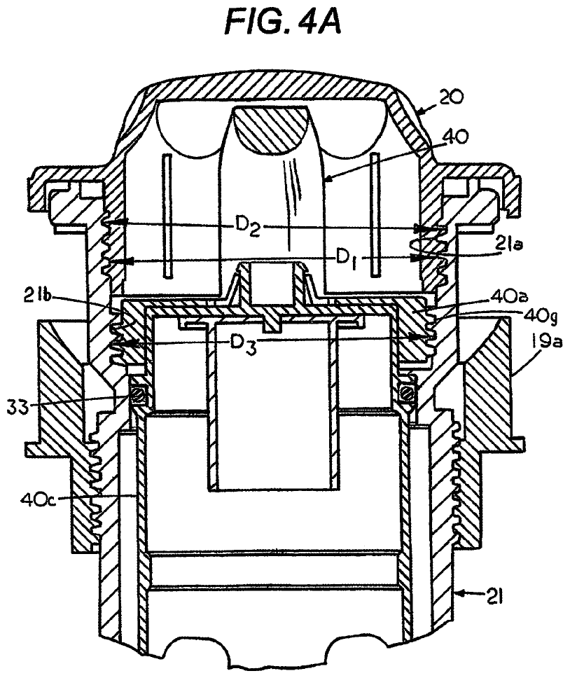

FIG. 4 is a sectional assembled view of a top end of inline well 12 revealing the multithreaded collar 21 having a set of external threads 21d and two sets of internal threads, a first set 21a and a second smaller set 21b, which are concentrically positioned with respect to each other along a central axis 50.

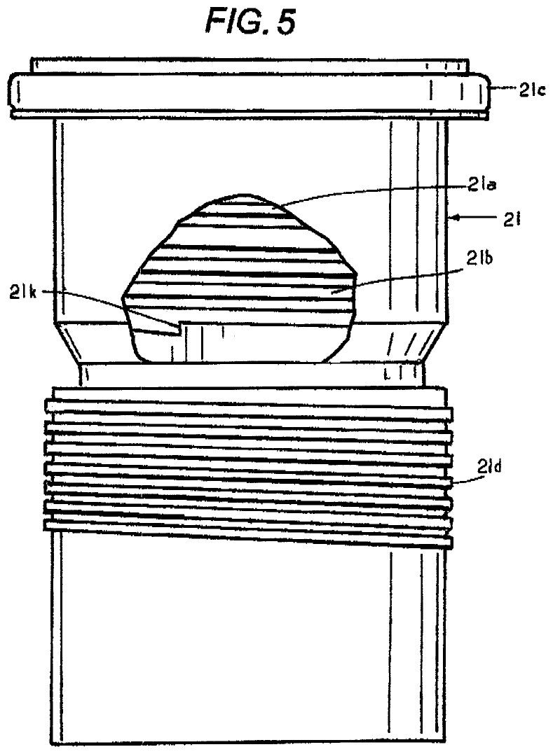

FIG. 4 shows an inline cap 20 in engagement with the first set of threads 21a and a rotatable cartridge carrier 40 in engagement with a second set of smaller threads 21b while FIG. 5 shows an isolated view of an example of a multithreaded collar 21 and FIG. 10 is an isolated view of an example of a rotatable cartridge carrier 40 for engagement with the multithread collar 21.

FIG. 4A shows the tooth and crown dimensions of collar 21 comprising a first set of internal threads 21a in multithreaded collar 21 having a diametrical crown to crown distance D₁ and a diametrical root to root distance D₂. FIG. 4A also shows a second set of internal threads 21b in collar 21 where a diametrical root to root distance D₃ is less than the diametrical crown to crown distance D₁ of the first set of female threads 21a. The relative dimensional sizing permits axial insertion and threaded engagement of cartridge carrier hub 40a past the first set of threads 21a and into mating engagement with the second set of male threads 21b, which has a diametrical crown to crown distance D₃, which is less than either the diametrical crown distance D₁ or root to root distance D₂. Thus, in this example multithreaded collar 21 includes a first set of internal threads 21a having the larger internal diameter threads proximate a top end of collar 21 with the second set of smaller diameter internal threads 21b located within the collar 21 and proximate the annular sealing surface 21c. The aforesaid thread arrangement allows cartridge carrier hub 40 to be axially inserted into threaded engagement with the smaller diameter internal threads 21b located within multithreaded collar 21 without engaging the first set of internal threads 21a.

FIG. 4B is an isolated view from FIG. 4 showing a top channel wall 40x on one side of sealing ring 33 and a lower channel wall 40y on the opposite side of sealing ring 33 connected with channel wall 40m with the channel walls cooperating to axially restrain sealing ring 33 therein as the sealing ring 33 is axially displaced into sealing engagement against annular sealing surface 21c through rotation of cartridge carrier hub 40a. That is external male hub threads 40g rotationally engage collar threads 21b to bring sealing ring 33 on cartridge carrier 40 into a sealing relationship with the annular sealing surface 21c on multithreaded collar 21.

In the example shown the first set of internal threads 21a on collar 21 form threaded engagement with a set of external threads 20a on well cap 20 to maintain well cap 20 thereon and a second set of internal threads 21b on collar 21 form threaded engagement with a set of external hub threads 40g on hub 40a to support cartridge carrier 40 thereon.

FIG. 4 and FIG. 4A show that when cartridge carrier hub 40a is in threaded engagement with collar threads 21b, it prevents axial displacement of hub 40a with respect to collar 21. Consequently, sealing ring 33 sealingly engages annular sealing surface 21c on collar 21 to maintain a water seal even when inline cap 20 is removed since cap 20 and cartridge carrier hub 40a are independently attached to collar 21 through separate sets of external threads. Thus, a feature of the invention is that with the present invention cap 20 can be removed from collar 21 without breaking the water seal formed between sealing ring 33 on cartridge carrier 40 and annular sealing surface 21c on collar 21. FIG. 4A illustrates the dimensional relationship that enables hub 40a to engage threads 21b but not threads 21a.

In the invention described herein rotational action of hub 40a is needed to insert or remove cartridge carrier 40 from collar 21. Consequently, sealing ring 33 remains in a sealing condition with sealing surface 21c until such rotational action is initiated. That is, to remove cartridge carrier 40 one grasps cartridge carrier handle 40b and rotates cartridge carrier hub threads 40g in a first direction that axially displaces hub 40a and breaks the seal formed between sealing surface 21c and sealing ring 33.

In contrast, to form the seal between sealing ring 33 and sealing surface 21c one rotates the cartridge carrier hub threads 40g in an opposite direction to axially displace the hub 30 into sealing engagement with sealing surface 21c.

FIG. 5 shows an isolated sectional view of an interior of the multithreaded collar 21 revealing a first set of large diameter (D₂) internal threads 21a and the second set of smaller diameter (D₃) internal threads 21b and a hub stop 21k locate below threads 21b that limits rotation of cartridge carrier hub 40a and hence the axial displacement of cartridge carrier 40.

In this example a set of external threads 21d on collar 21 enable mounting the multithreaded collar 21 to a frame of a hot tub; however, other types of fasteners may be used without departing from the spirit and scope of the invention.

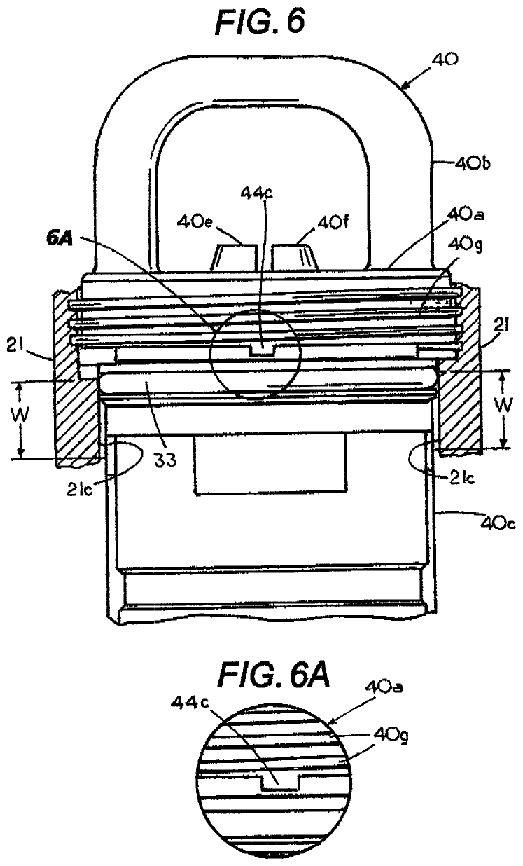

FIG. 6 is a partial view of cartridge carrier 40 and a partial view of multithreaded collar 21 showing an extension 44c on hub 40a that rotates with hub 40a. That is, if one grasps cartridge carrier handle 40b one can rotate hub 40a with respect to collar 21 to axially displace sealing ring 33 into sealing engagement with annular sealing surface 21c. Note, FIG. 6 shows the sealing ring 33 at a top end of annular sealing surface 21c. That is, cartridge carrier hub 40a has begun the axial downward displacement of sealing ring 33 into sealing engagement with annular sealing surface 21c on collar 21. Further displacement of sealing ring 33 (through rotation of hub 37) enables one to obtain a sealing relationship between sealing ring 33 and annular sealing surface 21c, which is also shown in FIG. 4 and FIG. 4A. Once the sealing relationship between the cartridge carrier 40 and the multithreaded collar 21 is obtained the rotation of hub 40 is stopped by an extension or stop 44c thereon.

FIG. 6A is an isolated view from FIG. 6 that reveals extension 44c and male threads 40g located on cartridge carrier hub 40a.

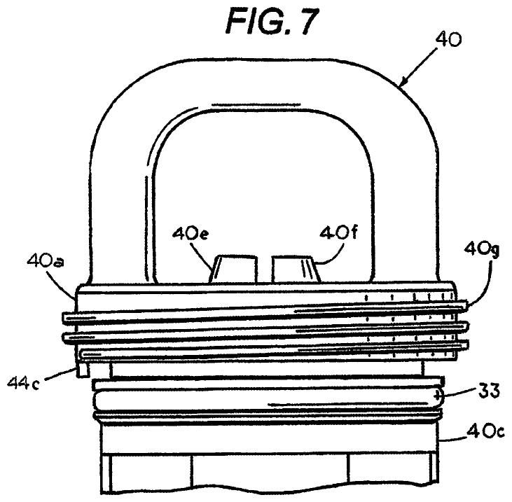

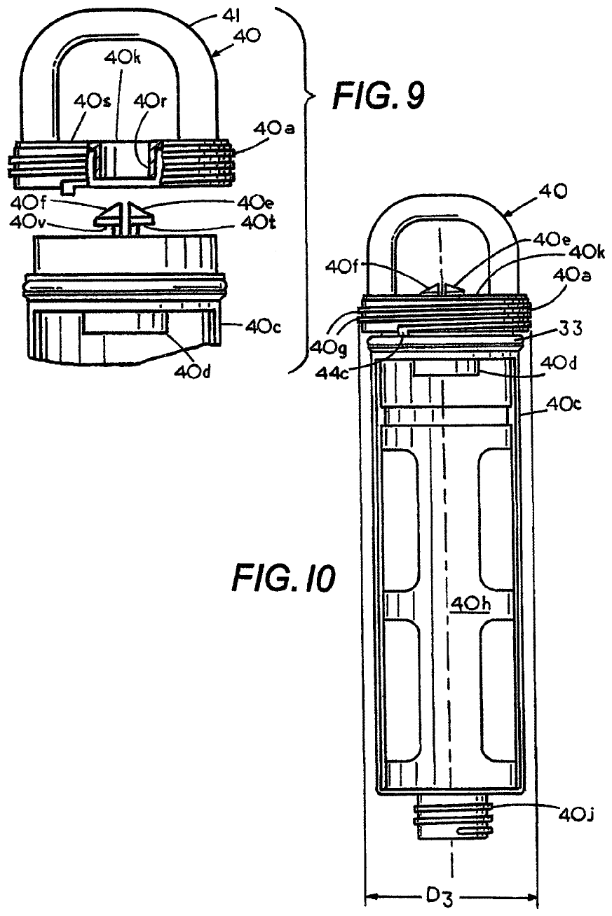

FIG. 7 is an isolated view of cartridge carrier 40 and cartridge carrier hub 40a, which is rotatable with respect to cartridge carrier skeleton housing 40c through a first resilient hook 40e and second resilient hook 40f, which are attached to the top end of skeleton housing 40. FIG. 9 is an exploded view of the rotatable hub 40a and the cartridge carrier skeleton housing 40c of FIG. 7 showing resilient hook 40e and resilient hook 40f in a position to be axially inserted into hub 40a for rotatably attachment with cartridge carrier skeleton housing top surface 40s.

FIG. 7 also shows cartridge carrier 40 with an external thread 40g with an extension 44c, which comprises a rotational stop, that limits rotation of hub 40a and thus stops axial displacement of sealing ring 33 with respect to annular sealing surface 21c.

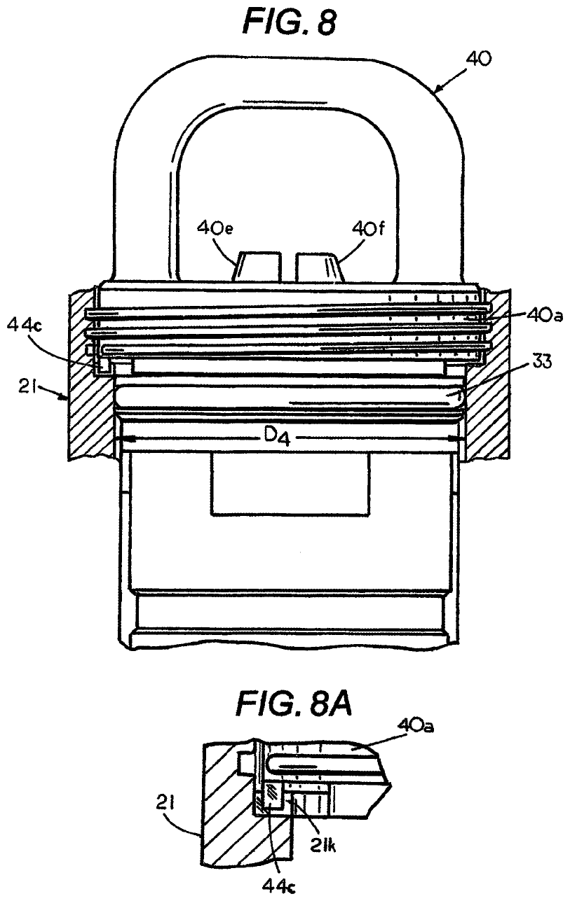

FIG. 8 shows sealing ring 33 fully engaged with annular sealing surface 21c thus ensuring an effective seal therebetween and FIG. 8A is an isolated view showing extension 44c on hub 40a in engagement with stop 21k to prevent further rotation of the hub 40a.

A further feature of the invention is illustrated in FIG. 8A, namely that rotation of hub 40a with handle 40b axially displaces sealing ring 33 into a proper sealing condition with sealing surface 21c. Once the sealing ring is in the proper sealing condition a stop 21k on collar 21 engages an extension 44c that prevents further rotation of hub 40a.

FIG. 9 and FIG. 10 show an example of cartridge carrier 40 with a hub 40a that is rotatable with respect to the skeleton housing 40c with FIG. 10 showing an assembled view of cartridge carrier hub 40a and skeleton housing 40c and FIG. 9 showing an exploded view of cartridge carrier hub 40a and skeleton housing 40c. FIG. 9 shows a set of resilient latches 40e and 40f, which are formed in the shape of hooks, that extend axially upward from a top surface of skeleton housing 40c. Latch 40e includes a bearing surface 40t and latch 40f also includes a bearing surface 40v which can rotatable engage bearing surface 40s on hub 40a when the resilient latches are extended through the central opening 40k in hub 40a. That is, latches 40e and 40f flex radial inward for insertion through central opening 40k having a sidewall 40r that forms a lateral bearing surface. Once the latches are inserted though opening 40k the underside 40v of hook 40f and the underside 40t of hook 40e engage a top bearing surface 40s on hub 40a with sufficient clearance that the cartridge carrier hub 40a can be rotated with respect to skeleton housing 40c by grasping and rotating handle 41 about a central axis of the skeleton housing 40c.

The example shown in FIG. 10 includes a cartridge carrier 40 having an interior chamber 40h for holding a first cartridge dispenser therein and a threaded end connector 40j for attaching a second cartridge dispenser thereto. Although a cartridge carrier for holding two cartridge dispensers is shown more or fewer cartridge dispensers may be attached to cartridge carrier hub 40a without departing from the spirit and scope of the invention.

We claim:

1. An inline well for delivery of a dispersant to a body of recreational water comprising:
a housing having a dispensing chamber with a water inlet and a water outlet;
a collar located in said housing;
a first set of internal threads in said collar, said first set of internal threads having a diametrical crown to crown distance D₁ and a diametrical root to root distance D₂;
a second set of internal threads in said collar having a diametrical root to root distance D₃ that is less than the diametrical crown to crown distance D₁ to permit axial insertion and threaded engagement with a hub having a set of external threads with a diametrical crown to crown distance D₃ that is less than the diametrical crown distance D₁.

2. The inline well of claim 1 wherein the first set of internal threads comprises a set of inline well cap threads.

3. The inline well of claim 2 where the collar includes a cap engaging flange.

4. The inline well of claim 3 including an inline end cap having an external flange engageable with the cap engaging flange.

5. The inline well of claim 1 where the collar includes a circumferential sealing surface extending axially along said collar.

6. The inline well of claim 1 including a cartridge carrier located in the inline well with the cartridge carrier including a hub having a set of threads engageable with the second set of female threads but not the first set of female threads to support the cartridge carrier thereon.

7. The inline well of claim 1 wherein the collar includes an external thread.

8. The inline well of claim 5 where the circumferential sealing surface has a diametrical distance which is less than diametrical root to root distance D₃.

9. The inline well of claim 6 including a sealing ring located in a circumferential channel on the cartridge carrier hub.

10. The inline well of claim 9 where a rotational engagement of the cartridge carrier forces the sealing ring into a sealing engagement between the cartridge carrier hub and the sealing surface of the collar.

11. The inline well of claim 9 wherein the cartridge carrier includes a handle and the cartridge carrier hub is in rotational engagement with a cartridge carrier skeleton housing.

12. The inline well of claim 6 where the inline well includes an extension and the cartridge carrier includes a stop that prevents rotation of the hub when the sealing ring is located in a sealing relationship with the sealing surface on the collar.

13. A hot tub comprising:
a container for a body of recreational water;
a pump for circulating the body of recreational water in the hot tub;
a seating area in said hot tub;
an inline well located in said hot tub; and
a collar in said inline well, said collar having a first set of internal threads rotationally supporting a cartridge carrier in said inline well and a second set of internal threads rotationally supporting an inline well cap with the first set of internal threads axially spaced from said second set of threads.

14. The hot tub of claim 13 wherein the collar includes a flange and the inline well cap includes a flange with the flange on the inline well cap engageable with the flange on the collar to limit rotational engagement of the inline well cap with respect to the collar.

15. The hot tub of claim 13 wherein the second set of threads on the collar are internal threads and the threads on the inline well cap are external threads.

16. The hot tub of claim 13 including a cartridge carrier having a hub rotationally supported in said collar with said cartridge carrier including a sealing ring forming sealing engagement with an annular sealing surface on said collar through rotation of said hub.

17. A cartridge carrier comprising:
a skeleton housing having a chamber for supporting a cartridge dispenser therein;
a sealing ring on said cartridge carrier;
a hub on said cartridge carrier with said hub having a set of threads, said hub rotatable into threaded engagement with an inline well as the sealing ring on the cartridge carrier is axially displaced into a sealing engagement with a sealing surface in an inline well through rotation of said hub.

18. The cartridge carrier of claim 17 wherein said hub includes a stop thereon to limit rotation of said hub.

19. The cartridge carrier of claim 17 wherein said sealing ring is axially engageable with an annular sealing surface in the inline well to prevent leakage therebetween.

20. The cartridge carrier of claim 17 where the skeleton housing is rotatably mounted to said hub for rotation of said hub without necessarily rotating said skeleton housing.

21. The cartridge carrier of claim 20 where the skeleton housing includes a compartment for holding at least one cartridge dispenser in a dispensing condition.

22. The cartridge carrier of claim 21 wherein skeleton housing includes an external connector for attachment of a further cartridge dispenser.

23. The cartridge carrier of claim 20 wherein the hub contains a handle for rotation of said hub independently of said skeleton housing.

24. The cartridge carrier of claim 20 where the hub includes a bearing surface for rotatable supporting the skeleton housing.

25. An inline well collar placeable in an inline well having an inlet and an outlet comprising:
a cylindrical housing having an exterior surface engageable with an interior of an inline well housing;
a first set of internal threads on the inside of the cylindrical housing with the first set of internal threads having a first diameter; and
a second set of internal threads on the inside of the well housing with the second set of internal threads located in coaxial alignment with the first set of threads where the first set of threads are sufficiently large that threaded engagement with the second set of internal heads can be obtained by axially inserting a threaded member through a diametrical opening in the first set of internal threads and into threaded engagement with the second set of internal threads.

26. The inline well collar of claim 25 including a circumferential sealing surface on the inside of the cylindrical housing.

27. The inline well collar of claim 25 including a flange on the cylindrical housing having a cap support surface located thereon, said cap support surface providing a circumferential seat when a cap is in threaded engagement with the first set of internal threads.

28. The inline well collar of claim 25 including a stop for limiting rotational engagement of a cartridge carrier with the second set of threads.

29. The inline well collar of claim 26 wherein the first set of threads are engageable with a set of threads on a well cap when a flange on the inline well cap is in a flange-to flange contact with a flange on the inline well collar.

30. The inline well collar of claim 26 where the circumferential sealing surface has a diametrical dimension less than a diametrical dimension of either the first set of threads or the second set of threads.

31. The inline well collar of claim 27 where a flange-to-flange contact of a well cap flange and the flange on the cylindrical housing provides support for the well cap and a sealing surface on the housing and a sealing ring on a cartridge carrier prevent a water leakage there past.

32. An inline well for delivery of a dispersant to a body of recreational water through a cartridge carrier comprising;
a housing having a dispensing chamber with a water inlet and a water outlet thereto;
an inline well collar located within said housing;
an annular sealing surface located within the collar; and
a set of threads located within the inline well collar with the annular sealing surface and the set of threads located coaxially with each other.

33. The inline well of claim 32 including a further set of threads located within the inline well collar and coaxial with the annular sealing surface.

34. The inline well of claim 33 where the further set of threads located within the collar are internal inline well cap threads for engaging an external male thread on a well cap with the further set of threads located at a top open end of the housing.

35. The inline well of claim 32 where the set of threads located within the inline well collar are cartridge carrier threads for engaging a set of threads on a rotatable cartridge carrier to axially displace a sealing ring on the cartridge carrier into a circumferential sealing engagement with the annular sealing surface on the inline well collar through rotation of cartridge carrier.

36. The inline well of claim 32 including a set of external threads located on the outside of the inline well collar for mounting the inline well collar to the hot tub.

37. The inline well of claim 32 with the collar including a flange for engaging a flange on an inline well cap.

38. The inline well of claim 32 wherein the inline well is located in a hot tub.

39. The inline well of claim 38 wherein the cartridge carrier includes a hub with the hub rotatable with respect to the cartridge carrier.

40. A method of forming a water seal between a cartridge carrier and a source of pressurized water in an inline well comprising:
inserting a cartridge carrier with a sealing ring thereon into an inline well;
engaging a set of threads on a cartridge carrier with a set of threads on a collar within the inline well;
rotating the cartridge carrier to axially displace the sealing ring on the cartridge carrier into engagement with a sealing surface on the collar; and
continue rotating the cartridge carrier until the sealing ring is axially displaced to form a water seal between the cartridge carrier and the sealing surface on the inline well.

41. The method of claim 40 including stopping the rotation of the cartridge carrier when the cartridge carrier engages a stop on the collar.

42. The method of claim 40 including axially displacing a hub on the cartridge carrier past a further set of threads on the collar and into engagement with a second set of threads on the collar before rotating the cartridge carrier.

43. The method of claim 42 including engaging a set of threads on an inline well cap with the further set of threads on the collar.

44. The method of claim 43 including rotating the inline well cap until a flange on the well cap engages a flange on the collar.

45. The method of claim 40 including placing a cartridge dispenser within a chamber in the cartridge carrier before inserting the cartridge carrier into the inline well.
